(19) United States
(12) Patent Application Publication
(10) Pub. No.: US 2014/0302194 A1
(43) Pub. Date: Oct. 9, 2014

(54) FEEDER INSECT COATING COMPOSITION AND METHOD

(71) Applicants: Gasparo Franco Marsala, Perth (AU); Miguel Angel Cubero-Marquez, Rossello (ES); Daniel James Holt, Tring (GB)

(72) Inventors: Gasparo Franco Marsala, Perth (AU); Miguel Angel Cubero-Marquez, Rossello (ES); Daniel James Holt, Tring (GB)

(21) Appl. No.: 13/858,996

(22) Filed: Apr. 9, 2013

(51) Int. Cl. A23K 1/00

(52) U.S. Cl. CPC A23K 1/004
USPC 426/1; 426/576; 426/575; 426/302

(57) ABSTRACT

The present invention is a composition for a feeder insect coating. Specifically, the invention relates to coating that can be applied to a feeder insect to increase the nutritional value of the feeder insect to provide a more complete food source to a consuming animal.

### FIELD OF THE INVENTION

The present invention is a composition for a feeder insect coating. Specifically, the invention relates to coating that can be applied to a feeder insect to increase the nutritional value of the feeder insect to provide a more complete food source to a consuming animal.

### BACKGROUND OF THE INVENTION

Around the world, zoos and other animal owners depend on feeder insects as a reliable food source for the creatures that they care for. These feeder insects serve as staple in many captive animals' diets, providing important nutrition that hopefully matches very closely the nutrition provided by the food sources in a given animal's natural environment. Often, however, nutritional profile of the feeder insect is inadequate as a complete food source for whatever animal consumes the feeder insect. Currently, there are certain additives available that can supplement a consuming animal's diet to make up for vitamins and other nutrients that are not provided by the feeder insect. These additives, however, fall short of creating a complete nutritional source that matches an animal's natural food source.

Therefore, there is a need in the art for a feeder insect coating composition that provides a more complete nutritional source by closely matching an animal's natural food source and remains palatable to the animal that is consuming it. These and other features and advantages of the present invention will be explained and will become obvious to one skilled in the art through the summary of the invention that follows.

### SUMMARY OF THE INVENTION

The present invention provides a range for a base composition and a process that is formulated to create a nutritive coating for a feeder insect. In certain embodiments, the composition may be formulated to accurately match the nutritional profile of a given animal's natural food sources.

According to an embodiment of the present invention, a composition for a feeder insect coating, the composition comprising: an amount of gelatin base, forming between 50-100% of the composition, comprising, an amount of water, forming between 50-80% of the gelatin base, an amount of an iodide source, forming between 0.05-1.00% of the gelatin base, an amount of a phosphate phosphorus source, forming between 0.50-3.00% of the gelatin base, an amount of a sodium source, forming between 0.50-2.00% of the gelatin base, an amount of an iron source, forming between 0.10-1.30% of the gelatin base, an amount of a pH corrector, forming between 0.10-2.00% of the gelatin base, an amount of a magnesium source, forming between 0.01-0.50% of the gelatin base, an amount a calcium source, forming between 0.10-1.00% of the gelatin base, an amount of a selenium source, forming between 0.01-0.20% of the gelatin base, an amount of a zinc source, forming between 0.01-0.20% of the gelatin base, and an amount of a protein source, forming between 10.00-35.00% of the gelatin base, and an amount of alginate solution, forming between 0-50% of the composition, comprising, an amount of water, forming between 97.00-99.80% of the alginate solution, and an amount of alginate, forming between 0.20-3.00% of the alginate solution.

According to an embodiment of the present invention, the water of the gelatin base is deionized water.

According to an embodiment of the present invention, the water of the gelatin base is distilled water.

According to an embodiment of the present invention, the gelatin base further includes an amount of a preservative, forming between 0.03-0.20% of the gelatin base.

According to an embodiment of the present invention, the gelatin base further includes an amount of a complexant, forming between 0-2.00% of the gelatin base.

According to an embodiment of the present invention, the gelatin base further includes an amount of an amino acid corrector, forming between 5-30% of said gelatin base.

According to an embodiment of the present invention, the water of the alginate solution is deionized water.

According to an embodiment of the present invention, the water of the alginate solution is distilled water.

According to an embodiment of the present invention, the alginate solution further comprises an amount of a preservative, forming between 0.03-0.20% of the alginate solution.

According to an embodiment of the present invention, the composition further comprises one or more attractant components.

According to an embodiment of the present invention, the gelatin base forms 100% of the composition.

According to an embodiment of the present invention, a method for enhancing the nutritive value of a feeder insect, the method comprising the steps of: preparing a coating, wherein the coating is formulated with one or more nutrients selected from a group nutrients comprising vitamins, minerals, and proteins; and covering the feeder insect with the coating, wherein the feeder insect remains palatable to a consuming animal, wherein the coating enhances the nutritional profile of the feeder insect to provide a more nutritionally complete food source to the consuming animal.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is flowchart of an exemplary process of formulating a gelatin base in accordance with an embodiment of the present invention;

FIG. 2 is flowchart of an exemplary process of formulating an alginate solution in accordance with an embodiment of the present invention; and

FIG. 3 is flowchart of an exemplary process of formulating feeder insect coating in accordance with an embodiment of the present invention.

### DETAILED DESCRIPTION OF THE INVENTION

The present invention is a composition for a feeder insect coating. Specifically, the invention relates to coating that can be applied to a feeder insect to increase the nutritional value of the feeder insect to provide a more complete food source to a consuming animal.

According to an embodiment of the present invention, the feeder insect coating is intended to nutritionally enhance the feeder insect that it is applied to. There are relatively few commercial feeder insects available to feed a broad range of species that have diverse nutritional requirements that are met through a broad array of naturally occurring food sources that are available to a given species. In other words, the limitation in available feeder insects forces species with diverse nutritional requirements to consume the same diet. By applying a coating to feeder insect, however, the nutritional profile of a feeder insect can be enhanced to better meet the nutritional requirements of any species that consumes a standard feeder insect.

According to an embodiment of the present invention, a feeder insect coating is comprised of a hydrocolloid and/or hydrocolloid blend. In a preferred embodiment, the feeder insect coating is formulated with a blend of 60% gelatin base and 40% alginate solution. In a secondary embodiment, the feeder insect coating may be formulated with 100% gelatin base. In further alternate embodiments, the formulation may be adjusted as necessary to ensure a stable formulation based upon the particular composition of both the gelatin base and the alginate solution. One of ordinary skill in the art would appreciate that a feeder insect coating may be blended in a variety of formulations, and embodiments of the present invention are contemplated for use with any such formulation.

According to an embodiment of the present invention, the feeder insect coating is comprised of a gelatin base. In a preferred embodiment, the gelatin base may be comprised of, but is not limited, water (50-80%), a iodide source (0.05-1.00%), an iron source (0.10-1.30%), a pH corrector (0.10-2.00%), a preservative (quantum satis), a magnesium source (0.01-0.50%), a calcium source (0.10-1.00%), a selenium source (0.01-0.20%), a zinc source (0.01-0.20%), a phosphorus source (0.50-3.00%), a sodium source (0.5-3.00%) and a protein source (10.00-35.00%). In a certain embodiment, the gelatin base may be formulated without a preservative. In certain embodiments, the gelatin base may be constituted of additional or fewer components. In certain embodiments, special nutrients, including, but not limited to, amino acids or glycerin, may be added to achieve specifically desired nutrient profiles. One of ordinary skill in the art would appreciate that gelatin based could be formulated with a variety of components, and embodiments of the present invention are contemplated for use with any such component.

According to an embodiment of the present invention, the gelatin base is comprised of water. In a preferred embodiment, the water amount of water varies depending upon the specific formulation. Specifically, the amount of water that should be added should be as much as necessary to achieve the desired result, given the amounts of the other components in the composition. In the preferred embodiment, the water is deionized water. In an alternate preferred embodiment, the water is distilled water. Using the above described sources of water ensures a consistent formulation of the final gelatin base product.

According to an embodiment of the present invention, the gelatin base is comprised of a potassium source. In a preferred embodiment, the iodide source is potassium iodide. In an alternate embodiment, the iodide source may be sodium iodide. One ordinary skill in the art would appreciate that the gelatin base could be formulated with a variety of iodide sources, and embodiments of the present invention are contemplated for use with any such iodide source.

According to an embodiment of the present invention, the gelatin base is comprised of a phosphorus source. In a preferred embodiment, the phosphorus source is sodium hydrogen phosphate (a/k/a disodium phosphate). In an alternate preferred embodiment, the phosphorus source is sodium dihydrogen phosphate (a/k/a monosodium phosphate). In alternate embodiments, the phosphorus source may be ammonia monophosphate or phosphoric acid. One ordinary skill in the art would appreciate that a gelatin base could be formulated with a variety of phosphorus sources, and embodiments of the present invention are contemplated for use with any such phosphorus source.

According to an embodiment of the present invention, the gelatin base is comprised of a sodium source. In a preferred embodiment, the sodium source is sodium hydrogen phosphate (a/k/a disodium phosphate). In an alternate preferred embodiment, the sodium source is sodium dihydrogen phosphate (a/k/a monosodium phosphate). In alternate embodiments, the sodium source may be sodium chloride or sodium bicarbonate. One ordinary skill in the art would appreciate that the gelatin base could be formulated with a variety of sodium sources, and embodiments of the present invention are contemplated for use with any such sodium source.

According to an embodiment of the present invention, the gelatin base is comprised of an iron source. In a preferred embodiment, the iron source is iron (II) sulfate, which may be in the form of either iron sulfate heptahydrate or iron sulfate monohydrate. In the preferred embodiment, the iron sulfate heptahydrate form is used. One ordinary skill in the art would appreciate that the gelatin base could be formulated with a variety of iron sources, and embodiments of the present invention are contemplated for use with any such iron source.

According to an embodiment of the present invention, the gelatin base is comprised of a pH corrector. In a preferred embodiment, the pH corrector is an organic acid. Organic acids that are suitable for use include, but are not limited to citric acid, ascorbic acid, malic acid, and lactic acid. In the preferred embodiment, the organic acid that is used is citric acid. One ordinary skill in the art would appreciate that the gelatin base could be formulated with a variety of pH correctors, and embodiments of the present invention are contemplated for use with any such pH corrector.

According to an embodiment of the present invention, the gelatin base is comprised of a preservative. In a preferred embodiment, the preservative is potassium benzoate. In alternate embodiments, other preservation methods such as pasteurization may be used. One ordinary skill in the art would appreciate that the gelatin base could be formulated with a variety of preservatives, and embodiments of the present invention are contemplated for use with any such preservative.

According to an embodiment of the present invention, the gelatin base is comprised of a magnesium source. In a preferred embodiment, the magnesium source is magnesium oxide. In alternate embodiments, the magnesium source may be magnesium sulfate or magnesium chloride. One ordinary skill in the art would appreciate that the gelatin base could be formulated with a variety of magnesium sources, and embodiments of the present invention are contemplated for use with any such magnesium source.

According to an embodiment of the present invention, the gelatin base is comprised of a calcium source. In a preferred embodiment, the calcium source is calcium carbonate. In an alternate embodiment, the calcium source is calcium lactate. One ordinary skill in the art would appreciate that the gelatin base could be formulated with a variety of calcium sources, and embodiments of the present invention are contemplated for use with any such calcium source.

According to an embodiment of the present invention, the gelatin base is comprised of a selenium source. In a preferred embodiment, the selenium source is sodium selenite. In an alternate embodiment, the selenium source is sodium selenite. One ordinary skill in the art would appreciate that the gelatin base could be formulated with a variety of selenium sources, and embodiments of the present invention are contemplated for use with any such selenium source.

According to an embodiment of the present invention, the gelatin base is comprised of a zinc source. In a preferred embodiment, the zinc source is zinc oxide. In an alternate embodiment, the zinc source may be zinc sulfate. One ordinary skill in the art would appreciate that the gelatin base could be formulated with a variety of zinc sources, and embodiments of the present invention are contemplated for use with any such zinc source.

According to an embodiment of the present invention, the gelatin base is comprised of a complexant. In a preferred embodiment, the complexant is sodium ethylenediaminetetraacetic acid (a/k/a sodium EDTA). One ordinary skill in the art would appreciate that the gelatin base could be formulated with a variety of complexants, and embodiments of the present invention are contemplated for use with any such complexant.

According to an embodiment of the present invention, the gelatin base is comprised of an amino acid corrector. In a preferred embodiment, the amino acid corrector helps to further fix and achieve a specific nutritional profile for the feeder insect coating. In the preferred embodiment, the amino acid corrector suitable for use include, but are not limited to, glycerin and other similar fats. One of ordinary skill in the art would appreciate there a numerous amino acid correctors that would be suitable for use, and embodiments of the present invention are contemplated for use with any such amino acid corrector.

According to an embodiment of the present invention, the gelatin base is comprised of a protein source. In a preferred embodiment, the protein source is gelatin. In the preferred embodiment, the gelatin is a pork gelatin. In alternate embodiments the gelatin source may be from another animal source. One ordinary skill in the art would appreciate that the gelatin base could be formulated with a variety of protein sources, and embodiments of the present invention are contemplated for use with any such protein source.

According to an embodiment of the present invention, the feeder insect coating is comprised of an alginate solution. In a preferred embodiment, the alginate solution may be comprised of, but is not limited, water (97.00-99.80%) and an alginate source (0.20-3.00%). In certain embodiments, the alginate solution may be constituted of additional or fewer components. One of ordinary skill in the art would appreciate that an alginate solution could be formulated with a variety of components, and embodiments of the present invention are contemplated for use with any such component.

According to an embodiment of the present invention, the alginate solution is comprised of water. In a preferred embodiment, the water is deionized water. In an alternate preferred embodiment, the water is distilled water. Using the above described sources of water ensures a consistent formulation of the final alginate solution product.

According to an embodiment of the present invention, the alginate solution is comprised of an alginate source. In a preferred embodiment, the alginate source is sodium alginate. One ordinary skill in the art would appreciate that the alginate solution could be formulated with a variety of alginate sources, and embodiments of the present invention are contemplated for use with any such alginate source.

According to an embodiment of the present invention, the alginate solution may be further comprised of a preservative. In a preferred embodiment, the preservative is potassium sorbate. In the preferred embodiment, the preservative is added to the alginate solution when the product is to be kept for more than two days. In alternate embodiments, other preservation methods such as pasteurization may be used. One of ordinary skill in the art would appreciate that a number of preservatives could be used in the alginate solution, and embodiments of the present invention are contemplated for use with such preservative.

According to an embodiment of the present invention, certain attractant components may be added to the composition to improve the palatability of the formula. In a preferred embodiment, these attractant components may improve the palatability of the formula by using aroma or volatiles to improve the olfactory attraction of the composition. In alternate preferred embodiments, color additives may be added to the composition in order to enhance the visual appeal of the formula. One of ordinary skill in the art would appreciate that there are numerous attractant components that might be added to the composition for the feeder insect coating, and embodiments of the present invention are contemplated for use with any such attractant component.

According to an embodiment of the present invention, the feeder insect coating is formulated to enhance the nutritional profile of a feeder insect. In a preferred embodiment, the feeder insect coating is formulated to match the nutritional profile of the natural food source of a particular species. As an illustrative example, a particular species may consume termites as its natural food source. Therefore, the feeder insect coating could be formulated to match the nutritional profile of a termite. Finally, by applying the termite formulated feeder insect coating to a feeder insect, a particular species would be provided with a complete nutritional source that matches what that species would consume in its natural habitat. One of ordinary skill in the art would appreciate that the feeder insect coating could be formulated to match a variety of natural foods sources, and embodiments of the present invention may be formulated to match any such natural food source.

According to an embodiment of the present invention, the feeder insect coating is formulated to enhance the nutritional profile of a feeder insect. In a preferred embodiment, the feeder insect coating is formulated to provide a complete nutrition source to a particular species. As an illustrative example, a particular species may consume multiple different food sources that collectively provide that species complete diet. Therefore, a feeder insect coating could be formulated that matches the nutritional profile of a species complete diet. By applying the complete diet formulated feeder insect coating to a feeder insect, a particular species would be provided with the same nutrition that the particular species would receive from the diet the species consumes in its natural environment. One of ordinary skill in the art would appreciate that the feeder insect coating could be formulated to match the nutrition of the diet of a variety of species, and embodiments of the present invention may be formulated to match the complete diet of any such species.

According to an embodiment of the present invention, the feeder insect coating is applied to a feeder insect to enhance the nutritional profile of the feeder insect. In a preferred embodiment, the feeder insect coating is formulated as a gel. In alternate embodiments, the feeder insect coating may be formulated in forms that include, but are not limited to, a liquid and a powder. One of ordinary skill in the art would appreciate that a feeder insect coating could be formulated in a variety of forms, and embodiments of the present invention are contemplated for use with any such form.

According to an embodiment of the present invention, the feeder insect coating is applied to a feeder insect to enhance the nutritional profile of the feeder insect. In a preferred embodiment, the feeder insect coating is applied to flat surface and the feeder insects are allowed to crawl or otherwise move through the feeder insect coating. In an alternate embodiment, the feeder insect coating may be poured over the feeder insects. In further alternate embodiments, the feeder insect coating may be applied through methods that include, but are not limited to, spraying the feeder insects and dipping the feeder insects. One of ordinary skill in the art would appreciate that there are numerous methods to apply a feeder insect coating to a feeder insect, and embodiments of the present invention are contemplated for use with any such coating method.

According to an embodiment of the present invention, a feeder insect covered with a feeder insect coating remains palatable to the animal that is consuming the feeder insect. In a preferred embodiment, the feeder insect is not harmed by the feeder insect coating. Additionally, the preferred embodiment of the feeder insect coating has no effect on the appeal of the feeder insect to an animal that consumes it. In an alternate preferred embodiment, the feeder insect coating enhances the appeal of a feeder insect to an animal that consumes it, while remaining harmless to the feeder insect itself. In all embodiments, it is important that the feeder insect coating not kill the feeder insect so as to make the feeder insect more palatable to the animal consuming it. In particular, it is important for the feeder insect to remain alive because i) the movement of the feeder insect can be attractive to the animal consuming it and ii) the feeder insect itself is an important source of protein and other nutrients, which can be damaged or diminished when the feeder insect dies.

According to an embodiment of the present invention, a feeder insect may be kept under chilled conditions in order to improve its preservation as a food source. In the preferred embodiment, the feeder insect is covered with a feeder insect coating and kept under chilled conditions for a period of one (1) day to one (1) month. Keep the feeder insect under chilled conditions improves the shelf-life of the feeder insect and allows for manipulation by the end user. One of ordinary skill in the art would appreciate that there are numerous benefits to keeping a feeder insect under chilled conditions, and embodiments of the present invention are contemplated to take advantage of any such benefit.

### Exemplary Embodiments

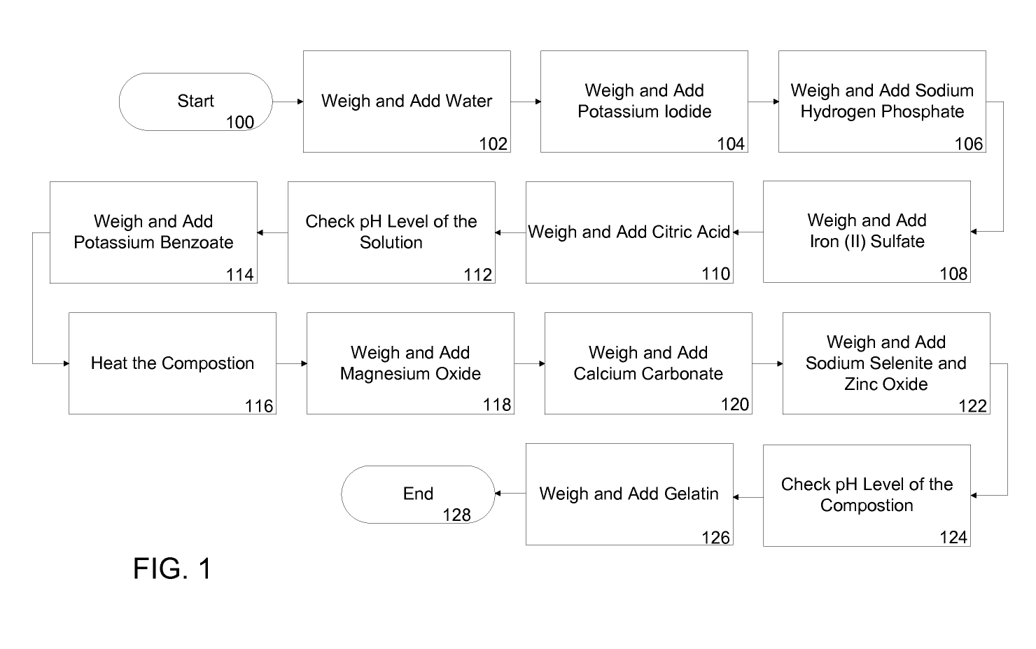

The following is an exemplary embodiment of a process for formulating a gelatin base, as shown in FIG. 1. At step 100, the process starts with gathering the materials necessary to formulate the gelatin base.

At step 102, the appropriate amount of water is weighed out and placed into a mixing vessel. The water should preferably be deionized water or distilled water, to ensure uniformity of results. The mixing vessel is preferably placed on a combination magnetic stirrer and hotplate. At this point in time, a gentle stir should be applied to the water.

At step 104, the appropriate amount of potassium iodide is weighed out and added to the water in the mixing vessel. The potassium iodide should be added directly to the water while being stirred and be completely dissolved before proceeding to the next step.

At step 106, the appropriate amount of sodium hydrogen phosphate is weighed out and added to the solution in the mixing vessel. The sodium hydrogen phosphate should be added directly to the solution while being stirred and be completely dissolved before proceeding to the next step.

At step 108, the appropriate amount of iron (II) sulfate is weighed out and added to the solution in the mixing vessel. The iron (II) sulfate should be added directly to the solution while being stirred and be completely dissolved before proceeding to the next step.

At step 110, the appropriate amount of citric acid is weighed out and added to the solution in the mixing vessel. The citric acid should be added directly to the solution while being stirred and be completely dissolved before proceeding to the next step.

At step 112, the pH level of the solution is checked. The pH level should be four (4) or lower to assure there are no issues in the proceeding steps. Instrumental analysis is not required, as pH paper is adequate for this step.

At step 114, the appropriate amount of potassium benzoate is weighed out and added to the solution in the mixing vessel. The potassium benzoate should be added directly to the solution while being stirred and be completely dissolved before proceeding to the next step.

At step 116, the solution is heated. The solution should be heated to 50-60° C. The temperature of the solution is important to dissolve further components of the composition.

At step 118, the appropriate amount of magnesium oxide is weighed out and added to the solution in the mixing vessel. The magnesium oxide should be added directly to the solution while being stirred. Proceed to the next step before complete dissolution, as this component will take time to dissolve.

At step 120, the appropriate amount of calcium carbonate is weighed out and added to the solution in the mixing vessel. The calcium carbonate should be added directly to the solution while being stirred. Proceed to the next step before complete dissolution, as this component will take time to dissolve.

At step 122, the appropriate amounts of sodium selenite and zinc oxide are weighed out and added to the solution in the mixing vessel. The sodium selenite and zinc oxide should be added directly to the solution while being stirred. Before proceeding to the next step, all components should be completely dissolved and the temperature of the solution should be brought to 50-60° C.

At step 124, the pH level of the solution is checked. At this step, if the pH of the solution is too alkaline, the solution will remain cloudy. This issue can be resolved by adding additional citric acid in 1-2 gram increments until the solution clears.

At step 126, the appropriate amount of gelatin is weighed out and added to the solution in the mixing vessel. The gelatin should be added slowly to the solution while being stirred with a high shear mixer, as opposed to the magnetic stir bar as in previous steps. When the gelatin has been completely dissolved, the stirring should cease.

At step 128, the gelatin base is complete and should be kept at a temperature of 35-45° C. until it is used.

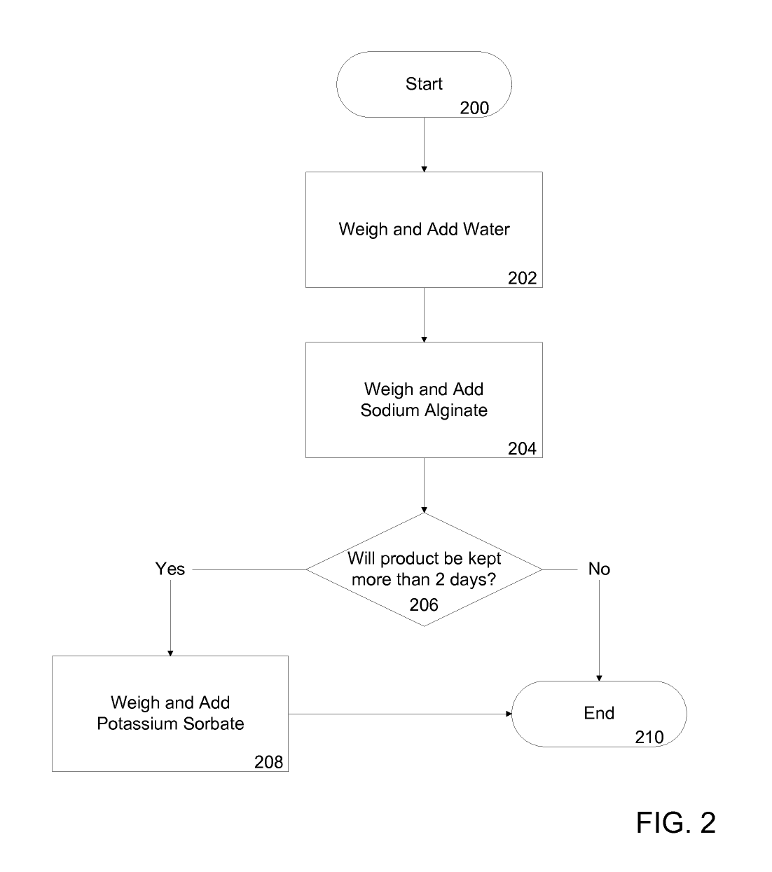

The following is an exemplary embodiment of a process for formulating an alginate solution, as shown in FIG. 2. At step 200, the process starts with gathering the materials necessary to formulate the alginate solution.

At step 202, the appropriate amount of water is weighed out and placed into a mixing vessel. The water should preferably be deionized water or distilled water, to ensure uniformity of results, and be stirred with a high shear mixer.

At step 204, the appropriate amount of sodium alginate is weighed out and added to the water in the mixing vessel. The sodium alginate should be added slowly to the water while being stirred.

At step 206, the it should be determined whether or not the solution will solution will be kept for more than 2 days. If the product is to be kept for more the two days, proceed to step 208. If the product will be used within two days, proceed to step 210.

At step 208, the appropriate amount of potassium sorbate is weighed out and added to the solution in the mixing vessel. The potassium sorbate will cause the solution to become more cloudy.

At step 210, the alginate solution is complete.

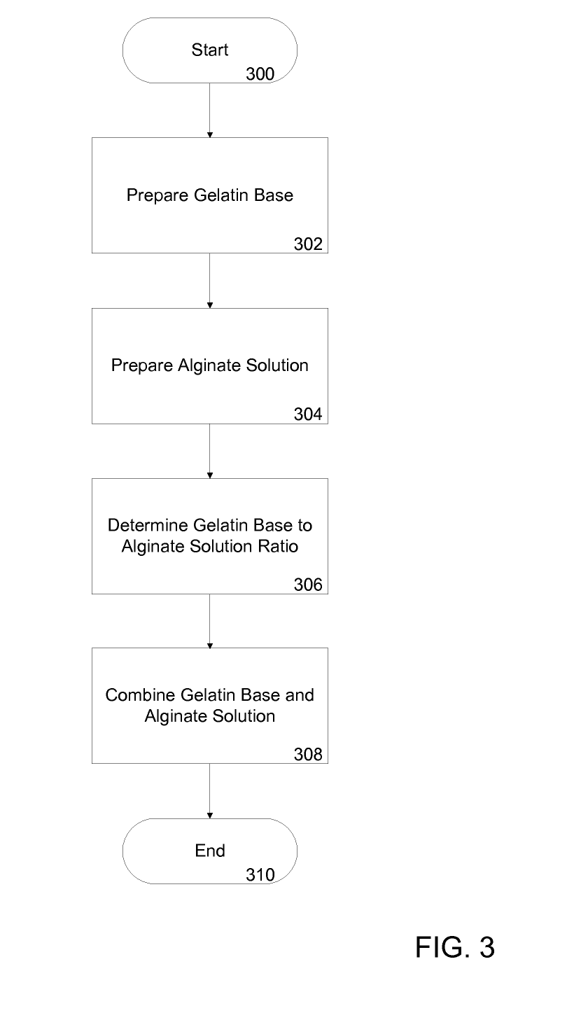

The following is an exemplary embodiment of a process for formulating a feeder insect coating, as shown in FIG. 3. At step 300, the process starts with gathering the materials necessary to formulate the feeder insect coating.

At step 302, the gelatin base is prepared, in a manner substantially similar to the process described in FIG. 1.

At step 304, the alginate solution is prepared, in a manner substantially similar to the process described in FIG. 2.

At step 306, the appropriate ratio of gelatin base to alginate solution is determined. In a preferred embodiment the feeder insect coating is 60% gelatin base and 40% alginate solution.

At step 308, the gelatin base is combined with the alginate solution in the appropriate ratio.

At step 310, the feeder insect coating is complete.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A composition for a feeder insect coating, said composition comprising:
an amount of gelatin base, forming between 50-100% of said composition, comprising,
an amount of water, forming between 50-80% of said gelatin base,
an amount of an iodide source, forming between 0.05-1.00% of said gelatin base,
an amount of a phosphate phosphorus source, forming between 0.50-3.00% of said gelatin base,
an amount of a sodium source, forming between 0.50-2.00 of said gelatin base,
an amount of an iron source, forming between 0.10-1.30% of said gelatin base,
an amount of a pH corrector, forming between 0.10-2.00% of said gelatin base,
an amount of a magnesium source, forming between 0.01-0.50% of said gelatin base,
an amount a calcium source, forming between 0.10-1.00% of said gelatin base,
an amount of a selenium source, forming between 0.01-0.20% of said gelatin base,
an amount of a zinc source, forming between 0.01-0.20% of said gelatin base,
and an amount of a protein source, forming between 10.00-35.00% of said gelatin base; and
an amount of alginate solution, forming between 0-50% of said composition, comprising,
an amount of water, forming between 97.00-99.80% of said alginate solution,
and an amount of alginate, forming between 0.20-3.00% of said alginate solution.

2. The composition of claim 1, wherein said water of said gelatin base is deionized water.

3. The composition of claim 1, wherein said water of said gelatin base is distilled water.

4. The composition of claim 1, wherein said gelatin base further comprises an amount of a preservative, forming between 0.03-0.20% of said gelatin base.

5. The composition of claim 1, wherein said gelatin base further comprises an amount of a complexant, forming between 0-2.00% of said gelatin base.

6. The composition of claim 1, wherein said gelatin base further comprises an amount of an amino acid corrector, forming between 5-30% of said gelatin base.

7. The composition of claim 1, wherein said water of said alginate solution is deionized water.

8. The composition of claim 1, wherein said water of said alginate solution is distilled water.

9. The composition of claim 1, wherein said alginate solution further comprises an amount of a preservative, forming between 0.03-0.20% of said alginate solution.

10. The composition of claim 1, wherein said composition further comprises one or more attractant components.

11. The composition of claim 1, wherein said gelatin base forms 100% of said composition.

12. A method for enhancing the nutritive value of a feeder insect, said method comprising the steps of:
preparing a coating, wherein said coating is formulated with one or more nutrients selected from a group nutrients comprising vitamins, minerals, and proteins; and
covering said feeder insect with said coating, wherein said feeder insect remains palatable to a consuming animal,
wherein said coating enhances the nutritional profile of said feeder insect to provide a more nutritionally complete food source to said consuming animal.
